(19) United States
(12) Patent Application Publication
(10) Pub. No.: US 2007/0067931 A1
(43) Pub. Date: Mar. 29, 2007

(54) Cleaner for Suction Coagulator

(76) Inventor: Joel A. Ernster, Colorado Springs, CO (US)

Correspondence Address: PETER F WEINBERG;GIBSON DUNN AND CRUTCHER LLP, SUITE 4100, 1801 CALIFORNIA STREET, DENVER, CO, 80202, US

(21) Appl. No.: 11/534,641

(22) Filed: Sep. 23, 2006

Related U.S. Application Data
(60) Provisional application No. 60/720,269, filed on Sep. 23, 2005.

(51) Int. Cl. B08B 7/00; B08B 9/00; B08B 1/00

(52) U.S. Cl. 15/104.03; 15/104.05; 15/104.04; 134/6; 134/33

(57) ABSTRACT

A cleaning device for cleaning a tubular device such as a coagulator has a generally cylindrical sidewall and a prong emerging from a base. To use the cleaning device, the coagulator tube is inserted onto the prong and rotated. The device has wipers that will wipe and clean the device as it is rotated. Preferably the device has wipers of different sizes to provide different wiping effects, such as cleaning two different sections of the coagulator tube having different diameters. The differently sized wipers may also be useful to clean tubes having different diameters.

### CROSS REFERENCE TO RELATED APPLICATION

The present patent application is related to and claims the benefit of priority from commonly-owned U.S. Provisional Patent Application No. 60/720,269, filed on Sep. 23, 2005, which is hereby incorporated by reference in its entirety.

### FIELD OF THE INVENTION

The present invention relates to the field of medical instruments. More particularly, the invention relates to a cleaner for cleaning a suction coagulator or like instrument.

### DESCRIPTION OF RELATED ART

The present invention is in some ways similar to the device described in the inventor's previously issued U.S. Pat. No. 6,250,315, the contents of which are incorporated herein.

### SUMMARY

A cleaning device for cleaning a tubular device such as a coagulator has a generally cylindrical sidewall and prong emerging from a base. To use the cleaning device, the coagulator tube is inserted onto the prong and rotated. The device has wipers that will wipe and clean the device as it is rotated. Preferably the device has wipers of different sizes to provide different wiping effects, such as cleaning two different sections of the coagulator tube having different diameters. The differently sized wipers may also be useful to clean tubes having different diameters.

### BRIEF DESCRIPTION OF THE DRAWINGS

The invention is shown in the attached figures, in which

FIG. 1 is a perspective view of a device according to an embodiment of the invention,

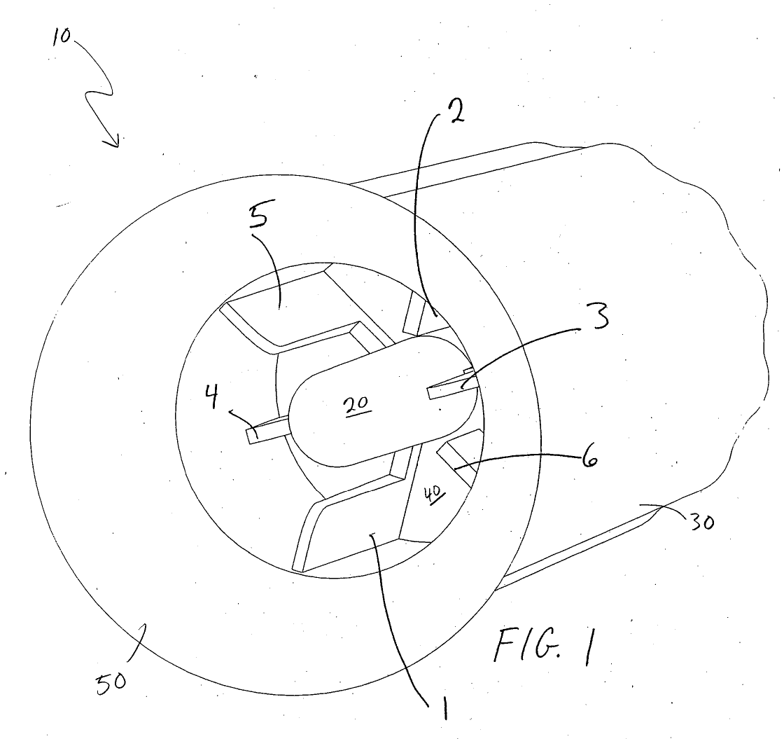

FIG. 2 is a top view of the device,

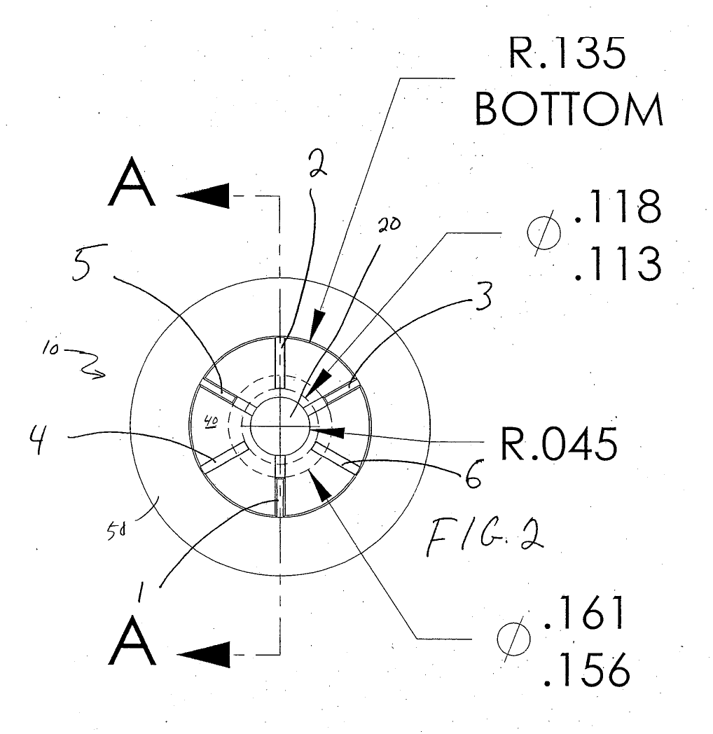

FIG. 3 is a sectional view of the device, taken along the line A-A in FIG. 2,

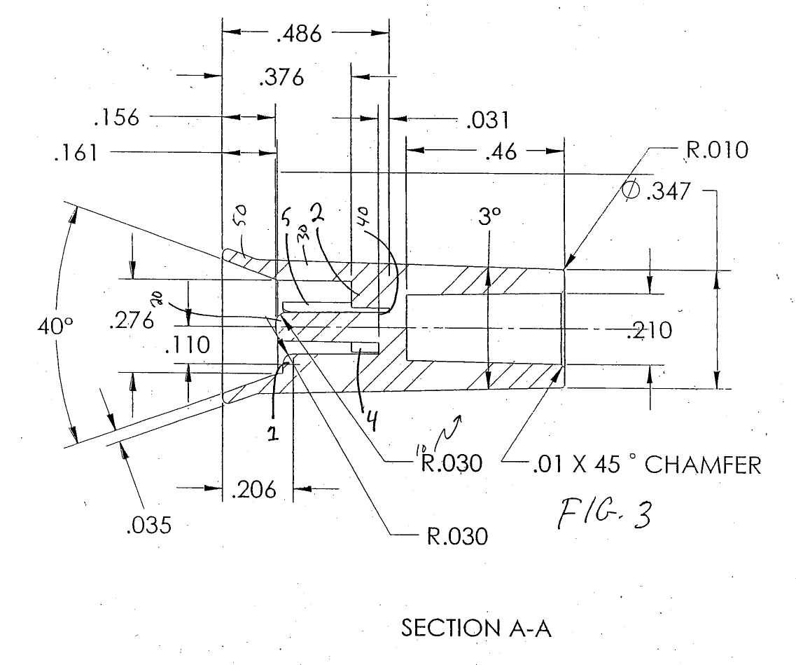

FIG. 4 is a side view of the device, and

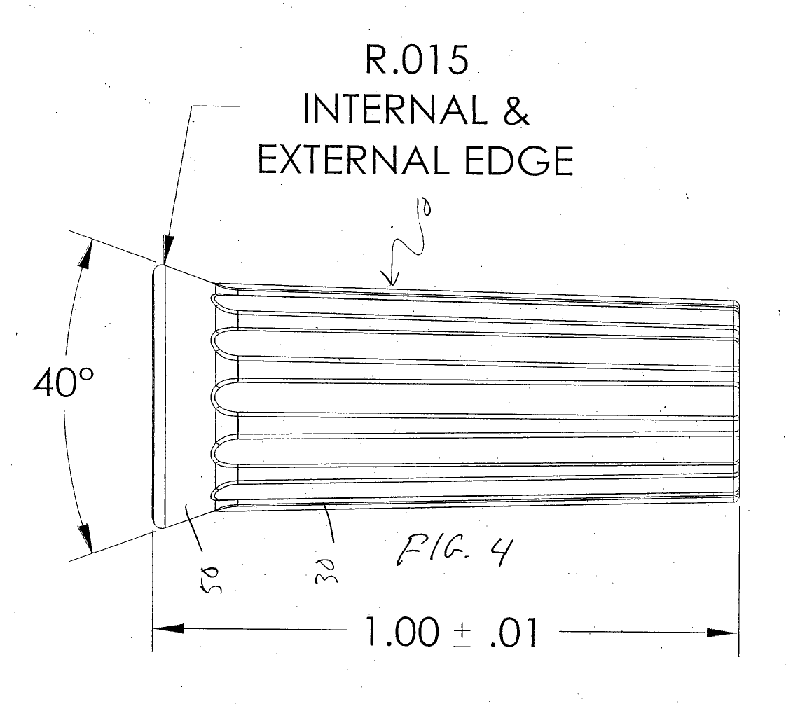

FIG. 5 is a bottom view of the device.

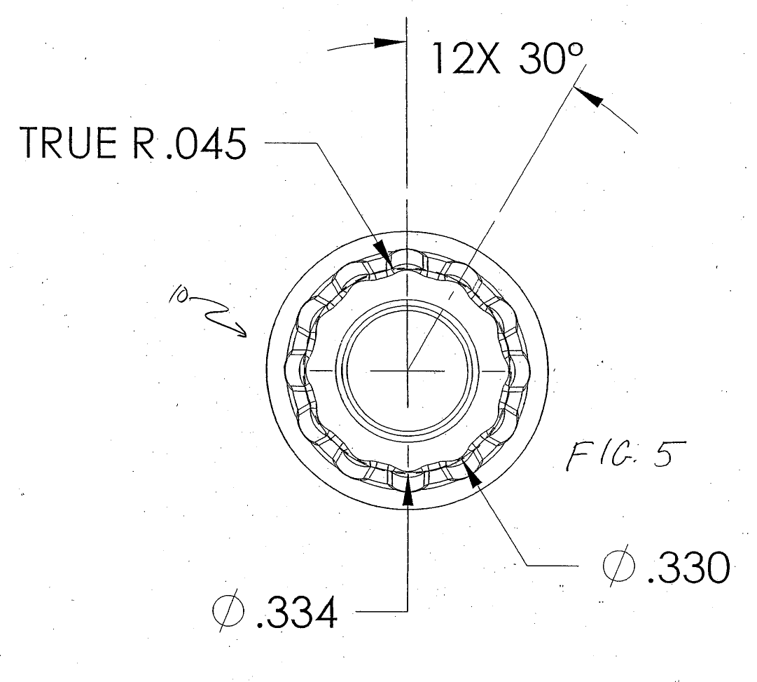

### DETAILED DESCRIPTION

A distinction between the present device and the inventor's previously patented device is the inclusion of six wipers 1-6 (it will be appreciated that the number of wipers isn't critical). The purpose of the wipers is that they clean the coagulator tube when the device is used as intended. In use, the user inserts the tube of the coagulator (not shown) into the cleaner 10 so that the tube is axially aligned with the prong 20 situated (at least partially) within the chamber formed by the cleaner sidewall 30. The user then preferably rotates the tube with respect to the coagulator so that the wipers 1-6 wipe the tube and thereby clean it in connection with the prong 20 and cleaner sidewall 30.

The wipers are preferably configured as follows. Wipers in a first set of wipers (shown as wipers 1, 3, and 5) extend from the cleaner sidewall 30 to the prong 20 less far than do wipers in a second set of wipes (shown as wipers 2, 4, and 6). Additionally, the first set of wipers (1, 3, 5) extends further from the base 40 of the cleaner than do the second set of wipers (2, 4, 6). That is, from a certain perspective, the wipers in the first set (1, 3, 5) are “high and narrow,” and the wipers in the second set (2, 4, 6) are “low and wide.” (The third dimension of the wipers, thickness, may be the same.) A significance of this is that, in operation, the coagulator tube when inserted first contacts the high and narrow wipers, and then contacts the low and wide wipers as the coagulator is further inserted.

The disclosed cleaner 10 has certain advantages compared to the device in U.S. Pat. No. 6,250,315. First, the two sizes of wipers are particularly good at cleaning the coagulator because in general it will have a distal exposed tip section (i.e., metal for coagulating) and then a proximal insulated section. The insulated section will have a somewhat greater diameter because of the thickness of the insulation. In operation, the “low and wide” wipers effectively wipe the relatively narrow tip section, and the “high and narrow” wipers wipe the insulated section. Moreover, the two sets of wipers are particularly effective in cleaning a range of coagulators as the same cleaning device may be used with coagulators that have somewhat different sizes, either because the coagulators were intended to have different sizes or because of manufacturing tolerances or the accumulation of debris. With two different sized wipers, one or the other size will likely be adapted to effectively clean the tube (including portions of the tube having different diameters). While the utility of the present device has been explained in the context of a suction coagulator (such as a nasal coagulator), the device may also have applicability in cleaning other tube devices, especially those having a tube of a varying diameter.

The cleaner 10 may have a flared end portion 50.

The various features may be useful either alone or in any combination. Moreover, the present invention could of course be embodied other than through device shown in the drawings, which should be regarded as exemplary.

I claim:

1. A device for cleaning a coagulator comprising:
a cylindrical sidewall that forms a chamber within the sidewall;
a prong positioned within the chamber so that a coagulator bore may fit onto the prong; and
at least one wiper extending from the sidewall toward the prong, whereby the at least one wiper will wipe the coagulator in operation.

2. A device according to claim 1, further comprising at least one other wiper extending from the sidewall toward the prong, wherein the at least one other wiper is sized differently from the first-mentioned wiper.

3. A device according to claim 2, wherein one of the wipers extends further toward the prong than the other wiper.

4. A device according to claim 2, wherein the prong extends from a base of the cleaner, both of the wipers extend from the direction of the base, and one of the wipers extends farther from the base then other wiper.

5. A device according to claim 2, wherein one of the wipers extends further from the base and less far toward the prong and than the other wiper.

6. A device for cleaning a coagulator comprising:
a cylindrical sidewall that forms a chamber within the sidewall;
a prong positioned within said chamber, so that a coagulator bore may fitted onto the prong, the prong extending from a base of the chamber;
a first set of wipers, wherein each wiper in the first set extends from the sidewall toward the prong and from the direction of the base so that the at the first set of wipers will wipe the coagulator in operation;
a second set of wipers wiper extending from the sidewall toward the prong and from the direction of the base so that the second set of wipers will wipe the coagulator in operation;
wherein the wipers in the first set extend further from the base and less far toward the prong than the wipers in the second set.

7. A device according to claim 6, wherein each set of wipers comprises three wipers.

8. A method of cleaning a coagulator tube comprising the following steps:
inserting the tube of the coagulator into a cleaner so that the tube is axially aligned with the a prong situated, at least partially, within a chamber of the cleaner formed by the cleaner sidewall;
rotating the tube with respect to the coagulator so that at least one wiper located in the chamber wipes the tube and thereby cleans it in connection with the prong.

9. A method according to claim 8, wherein the at least one wiper comprises at least two wipers.

10. A method according to claim 9, wherein the at least two wipers are different sizes.

11. A method according to claim 10, wherein one of the wipers extends farther from the sidewall to the prong than the other wiper.

12. A method according to claim 10, wherein the prong emerges from a base, and one of the wipers extends farther from the base than the other wiper.

13. A method according to claim 10, wherein the prong emerges from a base, and one of the wipers extends farther from the base and less far toward the prong than the other wiper.

14. A method according to claim 8, wherein the cleaner has a first set of wipers, wherein each wiper in the first set extends from the sidewall toward the prong and from the direction of the base from which the prong emerges so that the first set of wipers will wipe the coagulator in operation; and the cleaner has a second set of wipers extending from the sidewall toward the prong and from the direction of the base so that the second set of wipers will wipe the coagulator in operation; wherein the wipers in the first set extend further from the direction of the base and less far toward the prong than the wipers in the second set.

15. A method according to claim 14, wherein the coagulator has two different sections having different diameters so that, in operation of the cleaning device, the first set of wipers engage one tube section and the second set of wipers engage the other tube section.
